(19) United States
(12) Patent Application Publication
(10) Pub. No.: US 2005/0174050 A1
(43) Pub. Date: Aug. 11, 2005

(54) Electroluminescent device for keypads with electro-static discharge prevention layer

(76) Inventors: Wan-Soo Han, Hwaseong-si (KR); Ho-Seok Ko, Suwon-si (KR); Sang-Hoon Lee, Suwon-si (KR); Young-Woo Lee, Suwon-si (KR); Eung-Ryong Kim, Suwon-si (KR)

Correspondence Address: CANTOR COLBURN, LLP, 55 GRIFFIN ROAD SOUTH, BLOOMFIELD, CT, 06002, US

(21) Appl. No.: 11/054,117

(22) Filed: Feb. 9, 2005

(30) Foreign Application Priority Data
Feb. 10, 2004 (KR) 2004-8818

(51) Int. Cl. H01J 1/62; H01J 63/04

(52) U.S. Cl. 313/506

(57) ABSTRACT

An electroluminescent device for keypads capable of preventing electro-static discharge is provided, which includes a transparent insulating substrate; a top electrode layer entirely formed on one surface of the transparent insulating layer; an emission layer formed on a portion of the top electrode layer; an insulating layer formed on the emission layer; a bottom electrode layer formed on the insulating layer; a passivation layer formed on the top electrode layer to surround the emission layer, the insulating layer and the bottom electrode layer; and an electro-static discharge prevention layer formed on the other surface of the transparent substrate.

### CROSS-REFERENCE TO RELATED APPLICATION

This application claims priority to and the benefit of Korean Patent Application No. 2004-08818, filed Feb. 10, 2004, the disclosure of which is incorporated herein by reference in its entirety.

### BACKGROUND OF THE INVENTION

1. Field of the Invention

The present invention relates to an electroluminescent device for keypads and, more particularly, to an electroluminescent display for keypads including an electro-static discharge (ESD) prevention layer.

2. Description of the Related Art

FIG. 1 is a schematic plan view of a typical keypad, which illustrates only an arrangement state of keys. Referring to FIG. 1, the typical keypad 10 includes a plurality of keys 11. Typically, the keypad has a cut part 12 in order to improve click feeling of the keys, or a hole 13 for mechanical engagement. Otherwise, as shown in FIG. 1, an outer part 14 of the electroluminescent device for keypads may be cut.

As described above, when the hole is formed at the electroluminescent device for keypads, the keypad is cut in order to improve click feeling of the keys, or a hole for mechanical engagement. The top electrode layer of the electroluminescent device is exposed to a cut surface through the outer cutting, the electroluminescent device is likely to be damaged by electro-static discharge (ESD). Hereinafter, it will be described in conjunction with a cross-sectional structure taken along the line A-A′ in FIG. 1.

FIG. 2 illustrates a cross-sectional structure of an electroluminescent device for keypads according to a prior art. Referring to FIG. 2, the electroluminescent device for keypads includes a transparent insulating substrate 100, a top electrode layer 110 formed on the transparent insulating layer 100, an emission layer 123 formed on a portion of the top electrode layer 110, an insulating layer 126 formed on the emission layer 123, and a bottom electrode layer 129 formed on the insulating layer 126. In addition, a passivation layer 130 is formed to surround the emission layer 123, the insulating layer 126 and the bottom electrode layer 129.

The top electrode layer 110 made of a transparent conductive material such as ITO is formed on a bottom surface of the transparent insulating substrate 100 to be exposed to a cut surface 2 through the cut part 12 formed therein. That is, while the emission layer 123, the insulating layer 126 and the bottom electrode layer 129 are formed on the portion of the top electrode layer 110 to be surrounded by the passivation layer 130 not to be exposed to the cut surface 2, since the passivation layer 130 is formed on the top electrode layer 110, the top electrode layer 110 is not surrounded by the passivation layer 130 to be exposed to the cut surface 2.

Typically, in the electroluminescent device for keypads, the ESD is generated by an electric potential difference between electronic appliances and a human body or other materials, and the ESD is applied to the electronic appliances including the electroluminescent device therein. Static electricity generated at this time has thousands to tens of thousand voltage, each component in the appliances is affected by the static electricity introduced thereinto. The ESD flows to the top electrode layer 110 of the electroluminescent device exposed by the cut surface 2 to damage an output terminal of a driver connected to the top electrode layer 110.

Conventionally, in order to minimize the static electricity flowing through the electroluminescent device for keypads, peripheral elements in contact with the electroluminescent device are grounded to distribute the static electricity as widely as possible. That is, a front cover in contact with an upper end of the electroluminescent device for keypads and a dome pad in contact with a lower end are made of conductive materials, and the conductive materials are grounded. However, this method cannot sufficiently block the static electricity flowing through the electroluminescent device for keypads, thereby causing a malfunction of the driver.

### SUMMARY OF THE INVENTION

The present invention, therefore, solves aforementioned problems associated with conventional devices by providing an electroluminescent device for keypads capable of preventing a driver from being damaged due to ESD in the electroluminescent device for keypads.

In an exemplary embodiment of the present invention, an electroluminescent device for keypads includes: a transparent insulating substrate; a top electrode layer entirely formed on one surface of the transparent insulating substrate; an emission layer formed on a portion of the top electrode layer; an insulating layer formed on the emission layer; a bottom electrode layer formed on the insulating layer; a passivation layer formed on the top electrode layer to surround the emission layer, the insulating layer and the bottom electrode layer; and an electro-static discharge prevention layer formed on the other surface of the transparent substrate.

The electro-static discharge prevention layer may be connected to an external ground to be grounded. The electro-static discharge prevention layer may be entirely formed on one surface of the insulating substrate, and made of a transparent conductive material. In addition, the electro-static discharge prevention layer may be formed on a portion of one surface of the insulating substrate, which does not correspond to the emission layer, and made of non-transparent conductive or transparent conductive layer. The keypad may include a cut surface for improving click feeling of keys, mechanical engagement and apparent shapes, the top electrode layer may be exposed through the cut surface, and the electro-static discharge prevention layer may be exposed through the cut surface and connected to an external ground.

In another exemplary embodiment according to the present invention, an electroluminescent device for keypads includes: a transparent insulating substrate; a top electrode layer formed on a portion of one surface of the transparent insulating substrate; an emission layer formed on the top electrode layer; an insulating layer formed on the emission layer; a bottom electrode layer formed on the insulating layer; and a passivation layer formed on one surface of the insulating layer to surround the top electrode layer, the emission layer, the insulating layer and the bottom electrode layer.

In still another exemplary embodiment according to the present invention, an electroluminescent device for keypads includes: a transparent insulating substrate; a top electrode layer formed on a portion of one surface of the transparent insulating substrate; an emission layer formed on the top electrode layer; an insulating layer formed on the emission layer; a bottom electrode layer formed on the insulating layer; a passivation layer formed on one surface of the insulating layer to surround the top electrode layer, the emission layer, the insulating layer and the bottom electrode layer; and an electro-static discharge prevention layer formed on the other surface of the transparent substrate.

The electro-static discharge prevention layer may be connected to an external ground to be grounded. The electro-static discharge prevention layer may be entirely formed on one surface of the insulating substrate, and made of a transparent conductive material. In addition, the electro-static discharge prevention layer may be formed on a portion of one surface of the insulating substrate, which does not correspond to the emission layer, and made of non-transparent conductive or transparent conductive layer. The keypad may include a cut surface for improving click feeling of keys, mechanical engagement and apparent shapes, and the electro-static discharge prevention layer may be exposed through the cut surface and connected to an external ground.

### BRIEF DESCRIPTION OF THE DRAWINGS

The above and other features of the present invention will be described in reference to certain exemplary embodiments thereof with reference to the attached drawings in which:

FIG. 1 is a schematic plan view of a typical keypad;

FIG. 2 is a cross-sectional view of a conventional electroluminescent device for keypads;

FIG. 3 is a cross-sectional view of an electroluminescent device for keypads in accordance with a first embodiment of the present invention;

FIG. 4 is a cross-sectional view of an electroluminescent device for keypads in accordance with a second embodiment of the present invention;

FIG. 5 is a cross-sectional view of an electroluminescent device for keypads in accordance with a third embodiment of the present invention;

FIG. 6 is a cross-sectional view of an electroluminescent device for keypads in accordance with a fourth embodiment of the present invention; and

FIG. 7 is a cross-sectional view of an electroluminescent device for keypads in accordance with a fifth embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, length and thickness of layers and regions may be exaggerated for clarity. Like reference numerals designate like elements throughout the specification.

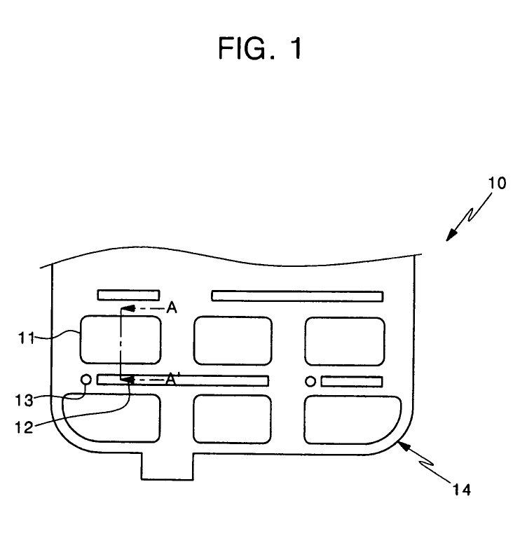

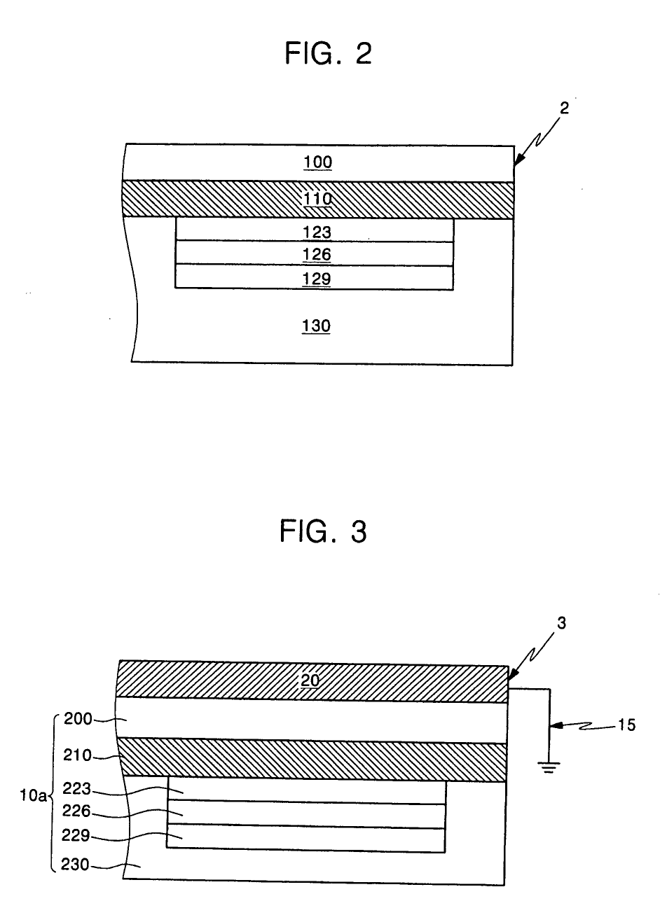

FIG. 3 is a cross-sectional view of an electroluminescent device for keypads in accordance with a first embodiment of the present invention, illustrating only the electroluminescent device of the cross-section taken along the line A-A′ in FIG. 1.

Referring to FIG. 3, the electroluminescent device 10a includes: a transparent insulating substrate 200; a top electrode layer 210 entirely formed on one surface for example, a bottom surface of the transparent insulating layer 200; an emission layer 223 formed on a portion of the top electrode layer; an insulating layer 226 formed on the emission layer 223, as a dielectric layer; and a bottom electrode layer 229 formed on the insulating layer 226. In addition, a passivation layer 230 is formed on the top electrode layer 210 to surround the emission layer 223, the insulating layer 226 and the bottom electrode layer 229.

In addition, an electro-static discharge (ESD) prevention layer 20 is entirely formed on the other surface, for example, a top surface of the transparent insulating substrate 200. The ESD prevention layer 20 is preferably formed of a transparent conductive material such as an ITO layer to prevent discharge of light emitted from the emission layer 223 from decreasing. Further, the ESD prevention layer 20 is exposed through a cut surface 3 and connected to an external ground 15 in order to protect other components in a driving circuit and an electronic appliance by flowing the ESD transmitted to the electroluminescent device for keypads to the exterior.

Therefore, in the first embodiment of the present invention, the top electrode layer 210 is entirely formed on the bottom surface of the transparent insulating substrate 200 using a transparent conductive material such as ITO to allow ESD introduced from the exterior to be discharged to the external ground via the ESD prevention layer 20. Thus, although the top electrode layer 223 is exposed to the cut surface 3 due to formation of the cut part 12 (see FIG. 1), it is possible to prevent the top electrode layer 210 exposed to the cut surface from being affected. As a result, it is possible to protect the other components in the driving circuit and the electronic appliance from the ESD transmitted to the electroluminescent device for keypads by the ESD prevention layer 20.

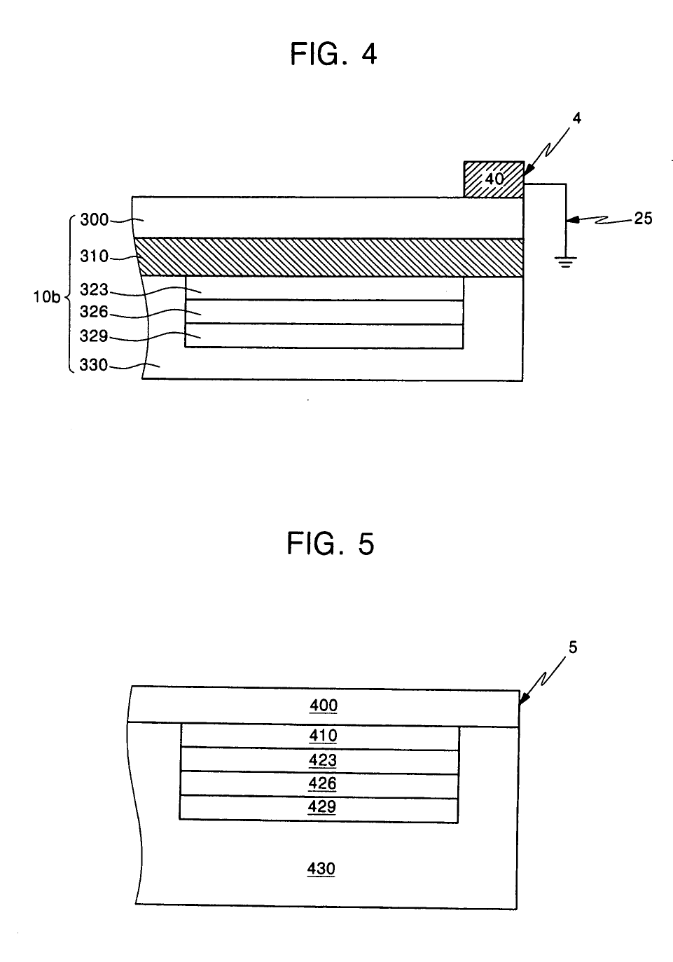

FIG. 4 is a cross-sectional view of an electroluminescent device for keypads in accordance with a second embodiment of the present invention, similar to that of the first embodiment shown in FIG. 3. However, while the ESD prevention layer 20 is entirely formed on the top surface of the transparent insulating substrate 200 in the first embodiment, an ESD prevention layer 40 is formed on a portion of the top surface of the transparent insulating substrate 200 in the second embodiment.

Referring to FIG. 4, the electroluminescent device 10b includes: a transparent insulating substrate 300; a top electrode layer 310 entirely formed on one surface for example, a bottom surface of the transparent insulating layer 300; an emission layer 323 formed on a portion of the top electrode layer 310; an insulating layer 326 formed on the emission layer 323, as a dielectric layer; and a bottom electrode layer 329 formed on the insulating layer 326. In addition, a passivation layer 330 is formed on the top electrode layer 310 to surround the emission layer 323, the insulating layer 326 and the bottom electrode layer 329.

In addition, an electro-static discharge (ESD) prevention layer 40 is partially formed on the other surface, for example, a top surface of the transparent insulating substrate 300. In order to prevent discharge of light emitted from the emission layer 323 from decreasing, preferably the ESD prevention layer 40 is locally formed on a portion of a top surface of the insulating substrate 300 except for an emission region, and more preferably formed at a region where the cut is performed. Therefore, the ESD prevention layer 40 is preferably formed of a transparent conductive material such as an ITO layer or a non-transparent conductive material such as Ag. Further, the ESD prevention layer 40 is connected to an external ground 25 in order to protect other components in a driving circuit and an electronic appliance by flowing the ESD transmitted to the electroluminescent device for keypads to the exterior.

As the ESD prevention layer 40 is grounded to the external ground 25 using the method, it is possible to prevent the ESD from being transmitted to the electroluminescent device for keypads, and therefore to prevent a driver from being damaged.

FIG. 5 is a cross-sectional view of an electroluminescent device for keypads in accordance with a third embodiment of the present invention, illustrating only the electroluminescent device of the cross-section taken along the line A-A′ in FIG. 1.

Referring to FIG. 5, the electroluminescent device includes a transparent insulating substrate 400; a top electrode layer 410 formed on a portion of one surface for example, a bottom surface of the transparent insulating layer 400 and corresponding to an emission region of the electroluminescent device; an emission layer 423 formed on the top electrode layer 410; an insulating layer 426 formed on the emission layer 423, as a dielectric layer; and a bottom electrode layer 429 formed on the insulating layer 426. In addition, a passivation layer 430 is formed on the bottom surface of the insulating substrate 400 to surround the top electrode layer 410, the emission layer 423, the insulating layer 426 and the bottom electrode layer 429.

In the third embodiment of the present invention, in order to protect the electroluminescent device from the ESD transmitted to the electroluminescent device, the top electrode layer 410 is formed on the portion of the insulating substrate 400 corresponding to an emission region of the electroluminescent device such that the top electrode layer 410 is not exposed by the cut surface 5, other than forming the separate ESD prevention layers 20 and 40 as the first and second embodiments. Therefore, it is possible to prevent the ESD transmitted to the electroluminescent device for keypads from flowing to the top electrode layer 410 to thereby protect other components in a driving circuit and an electronic appliance.

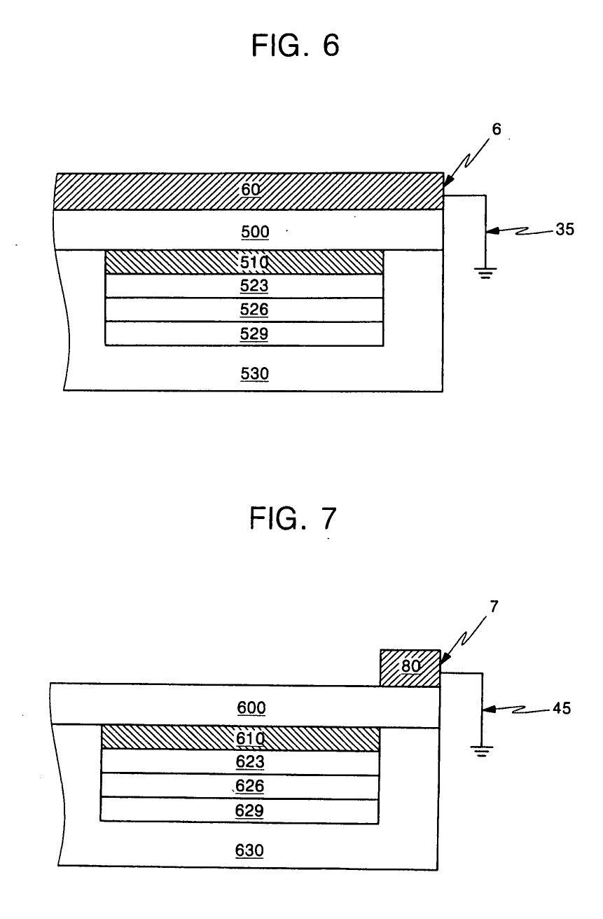

FIG. 6 is a cross-sectional view of an electroluminescent device for keypads in accordance with a fourth embodiment of the present invention, illustrating only the electroluminescent device of the cross-section taken along the line A-A′ in FIG. 1.

Referring to FIG. 6, the electroluminescent device includes a transparent insulating substrate 500; a top electrode layer 510 formed on a portion of one surface for example, a bottom surface of the transparent insulating layer 500 and corresponding to an emission region of the electroluminescent device; an emission layer 523 formed on the top electrode layer 510; an insulating layer 526 formed on the emission layer 523, as a dielectric layer; and a bottom electrode layer 529 formed on the insulating layer 526. In addition, a passivation layer 530 is formed on the bottom surface of the insulating substrate 500 to surround the top electrode layer 510, the emission layer 523, the insulating layer 526 and the bottom electrode layer 529.

In the fourth embodiment of the present invention, in order to protect the electroluminescent device from the ESD transmitted to the electroluminescent device, the top electrode layer 510 is formed on the portion of the insulating substrate 500 corresponding to an emission region of the electroluminescent device such that the top electrode layer 510 is not exposed by the cut surface 6. Therefore, it is possible to prevent the ESD transmitted to the electroluminescent device for keypads from flowing to the top electrode layer 510.

In addition, in the fourth embodiment, an ESD prevention layer 60 is entirely formed on the other surface, for example, a top surface of the transparent insulating substrate 500. Preferably, the ESD prevention layer 60 is formed of a transparent conductive material such as an ITO layer in order not to decrease emission of light emitted from the emission layer 523. In addition, the ESD prevention layer 60 is exposed through a cut surface 6 and connected to an external ground 35 in order to protect other components in a driving circuit and an electronic appliance by flowing the ESD transmitted to the electroluminescent device for keypads to the exterior.

Therefore, in the fourth embodiment, it is possible to prevent the ESD from flowing to the top electrode layer 510 through the cut surface 6 and to discharge the ESD to the external ground 35 through the ESD prevention layer 60, thereby stably protecting the other components in the driving circuit and the electronic appliance.

FIG. 7 is a cross-sectional view of an electroluminescent device for keypads in accordance with a fifth embodiment of the present invention, similar to that of the fourth embodiment shown in FIG. 6. However, while an ESD prevention layer is entirely formed on a top surface of a transparent insulating substrate in the fourth embodiment, the ESD prevention layer is formed on a portion of the top surface of the transparent insulating substrate in the fifth embodiment.

Referring to FIG. 7, the electroluminescent device includes a transparent insulating substrate 600; a top electrode layer 610 formed on a portion of one surface for example, a bottom surface of the transparent insulating layer 600 and corresponding to an emission region of the electroluminescent device; an emission layer 623 formed on the top electrode layer 610; an insulating layer 626 formed on the emission layer 623, as a dielectric layer; and a bottom electrode layer 629 formed on the insulating layer 626. In addition, a passivation layer 630 is formed on the bottom surface of the insulating substrate 600 to surround the top electrode layer 610, the emission layer 623, the insulating layer 626 and the bottom electrode layer 629.

In the fifth embodiment of the present invention, in order to protect the electroluminescent device from the ESD transmitted to the electroluminescent device, the top electrode layer 610 is formed on the portion of the insulating substrate 600 corresponding to an emission region of the electroluminescent device such that the top electrode layer 610 is not exposed by the cut surface 7. Therefore, it is possible to prevent the ESD transmitted to the electroluminescent device for keypads from flowing to the top electrode layer 610.

In the fifth embodiment, an electro-static discharge (ESD) prevention layer 80 is partially formed on the other surface, for example, a top surface of the transparent insulating substrate 600. Preferably, the ESD prevention layer 80 is locally formed on a portion of a top surface of the insulating substrate 600 except for an emission region, and more preferably formed at a region where the cut is performed, in order not to decrease emission of light emitted from the emission layer 623. Therefore, the ESD prevention layer 80 is preferably formed of a transparent conductive material such as an ITO layer or a non-transparent conductive material such as Ag. Further, the ESD prevention layer 80 is connected to an external ground 45 in order to protect other components in a driving circuit and an electronic appliance by flowing the ESD transmitted to the electroluminescent device for keypads to the exterior.

Therefore, in the fifth embodiment, it is possible to prevent the ESD from flowing to the top electrode layer 610 through the cut surface 7 and to discharge the ESD to the external ground 45 through the ESD prevention layer 80, thereby stably protecting the other components in the driving circuit and the electronic appliance.

As can be seen from the foregoing, the top electrode layer of the electroluminescent device for keypads is formed to allow the top electrode layer to be not exposed by the cut surface or the separate ESD prevention layer is formed to be grounded, thereby protecting output terminals of the driver connected to the top electrode layer of the electroluminescent device for keypads from the ESD transmitted to the electroluminescent device and preventing components in the electronic appliance from being damaged due to the ESD.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

1. An electroluminescent device for keypads comprising:
a transparent insulating substrate;
a top electrode layer entirely formed on one surface of the transparent insulating substrate;
an emission layer formed on a portion of the top electrode layer;
an insulating layer formed on the emission layer;
a bottom electrode layer formed on the insulating layer;
a passivation layer formed on the top electrode layer to surround the emission layer, the insulating layer and the bottom electrode layer; and
an electro-static discharge prevention layer formed on the other surface of the transparent substrate.

2. The electroluminescent device for keypads according to claim 1, wherein the electro-static discharge prevention layer is connected to an external ground to be grounded.

3. The electroluminescent device for keypads according to claim 1, wherein the electro-static discharge prevention layer is entirely formed on one surface of the insulating substrate.

4. The electroluminescent device for keypads according to claim 3, wherein the electro-static discharge prevention layer is made of a transparent conductive material.

5. The electroluminescent device for keypads according to claim 1, wherein the electro-static discharge prevention layer is formed on a portion of the one surface of the insulating substrate, which does not correspond to the emission layer.

6. The electroluminescent device for keypads according to claim 5, wherein the electro-static discharge prevention layer is made of one of a non-transparent conductive layer and a transparent conductive layer.

7. The electroluminescent device for keypads according to claim 1, wherein the keypad comprises a cut surface for improving click feeling of keys, mechanical engagement and apparent shapes,
the top electrode layer is exposed through the cut surface, and
the electro-static discharge prevention layer is exposed through the cut surface and connected to an external ground.

8. An electroluminescent device for keypads comprising:
a transparent insulating substrate;
a top electrode layer formed on a portion of one surface of the transparent insulating substrate and corresponding to an emission region of the electroluminescent device;
an emission layer formed on the top electrode layer;
an insulating layer formed on the emission layer;
a bottom electrode layer formed on the insulating layer; and
a passivation layer formed on one surface of the insulating layer to surround the top electrode layer, the emission layer, the insulating layer and the bottom electrode layer.

9. The electroluminescent device for keypads according to claim 8, wherein the top electrode layer made of a transparent conductive material is formed on a portion of the one surface of the insulating substrate not to be exposed to the cut surface.

10. An electroluminescent device for keypads comprising:
a transparent insulating substrate;
a top electrode layer formed on a portion of one surface of the transparent insulating substrate and corresponding to an emission region of the electroluminescent device;
an emission layer formed on the top electrode layer;
an insulating layer formed on the emission layer;
a bottom electrode layer formed on the insulating layer;
a passivation layer formed on one surface of the insulating layer to surround the top electrode layer, the emission layer, the insulating layer and the bottom electrode layer; and
an electro-static discharge prevention layer formed on the other surface of the transparent substrate.

11. The electroluminescent device for keypads according to claim 10, wherein the top electrode layer made of a transparent conductive layer is formed on one surface of the insulating substrate not to be exposed to the cut surface.

12. The electroluminescent device for keypads according to claim 10, wherein the electro-static discharge prevention layer is connected to an external ground to be grounded.

13. The electroluminescent device for keypads according to claim 10, wherein the electro-static discharge prevention layer is entirely formed on the one surface of the insulating substrate.

14. The electroluminescent device for keypads according to claim 13, wherein the electro-static discharge prevention layer is made of a transparent conductive material.

15. The electroluminescent device for keypads according to claim 10, wherein the electro-static discharge prevention layer is formed on a portion of the one surface of the insulating substrate, which does not correspond to the emission layer.

16. The electroluminescent device for keypads according to claim 15, wherein the electro-static discharge prevention layer is made of one of a non-transparent conductive layer and a transparent conductive layer.

17. The electroluminescent device for keypads according to claim 10, wherein the keypad comprises a cut surface for improving click feeling of keys, mechanical engagement and apparent shapes, and
the electro-static discharge prevention layer is exposed through the cut surface and connected to an external ground.
